(19) United States
(12) Patent Application Publication
(10) Pub. No.: US 2012/0198919 A1
(43) Pub. Date: Aug. 9, 2012

(54) LIQUID SUPPLY WITH OPTIMIZED SWITCHING BETWEEN DIFFERENT SOLVENTS

(75) Inventors: Klaus Witt, Keltern (DE); Konstantin Choikhet, Karlsruhe (DE); Philip Herzog, Stutensee (DE)

(73) Assignee: AGILENT TECHNOLOGIES, INC., Santa Clara, CA (US)

(21) Appl. No.: 13/346,092

(22) Filed: Jan. 9, 2012

(30) Foreign Application Priority Data
Feb. 9, 2011 (GB) 1102219.1

(51) Int. Cl. G01N 11/00

(52) U.S. Cl. 73/53.01

(57) ABSTRACT

A method for metering two or more liquids in controlled proportions in a liquid supply system and for supplying a resultant mixture, in which the liquid supply system includes a plurality of solvent supply lines, a proportioning valve interposed between the solvent supply lines and an inlet of a pumping unit, the method includes drawing in a first liquid into the pumping unit via a first solvent supply line; determining one or more switching points of time for switching between different solvent supply lines, the switching points of time being determined in a way that at said switching points of time, the liquid supplied to the pumping unit is in a predefined pressure range; switching from the first solvent supply line to a second solvent supply line at one of said switching points of time; drawing in a second liquid into the pumping unit via the second solvent supply line.

### BACKGROUND ART

The present invention relates to a method for metering two or more liquids in controlled proportions, and to a liquid supply system. The present invention further relates to a liquid separation system, in particular in a high performance liquid chromatography application.

U.S. Pat. No. 4,018,685 discloses proportional valve switching for gradient formation. U.S. Pat. No. 4,595,496 discloses a liquid composition control for avoiding pump draw stroke non-uniformities. U.S. Pat. No. 4,980,059 discloses a liquid chromatograph. U.S. Pat. No. 5,135,658 discloses a coordinated chromatography system. U.S. Pat. No. 7,631,542 discloses a chromatography system with fluid intake management. U.S. Pat. No. 5,862,832 describes a gradient proportioning valve. International patent application WO 2010/030720 discloses a modulation of time offsets for solvent proportioning.

### DISCLOSURE

It is an object of the invention to provide an improved liquid supply capable of supplying composite liquids with high accuracy. The object is solved by the independent claim(s). Further embodiments are shown by the dependent claim(s).

A method for metering two or more liquids in controlled proportions in a liquid supply system and for supplying a resultant mixture is given, wherein the liquid supply system comprises a plurality of solvent supply lines, each fluidically connected with a reservoir containing a liquid, a proportioning valve interposed between the solvent supply lines and an inlet of a pumping unit, the proportioning valve configured for modulating solvent composition by sequentially coupling selected ones of the solvent supply lines with the inlet of the pumping unit, with the pumping unit being configured for taking in liquids from the selected solvent supply lines and for supplying a mixture of the liquids at its outlet; the method comprising: drawing in a first liquid into the pumping unit via a first solvent supply line; determining one or more switching points of time for switching between different solvent supply lines, the switching points of time being determined in a way that at said switching points of time, the liquid supplied to the pumping unit is in a predefined pressure range; switching from the first solvent supply line to a second solvent supply line at one of said switching points of time; drawing in a second liquid into the pumping unit via the second solvent supply line.

According to embodiments of the present invention, the switching points of time are chosen such that at the time of switching, the respective liquid is within the predefined pressure range. For example, the pressure range may be defined such that, at the point of switching, both a state of overpressure and a state of underpressure are avoided. In this case, at the point of switching from the first solvent to a second solvent, the solvent is neither in a compressed state nor in an expanded state. A compressed state or an expanded state of the solvent that is drawn in may cause compositional errors. Furthermore, due to the elasticity of the liquid supply system's tubing and the elasticity of other system components, a state of overpressure may e.g. lead to a corresponding dilation of the tubing, whereas a state of underpressure may e.g. correspond to a narrowing of the tubing. Hence, by avoiding a state of overpressure or a state of underpressure at the point of switching, compositional errors are reduced or even avoided.

According to a preferred embodiment of the invention, the method comprises monitoring pressure at the inlet of the pumping unit to determine the switching points of time for switching between different solvent supply lines.

According to a preferred embodiment of the invention, the method comprises determining the switching points of time in a way that at said switching points of time, the liquid supplied to the pumping unit essentially is neither in a state of overpressure nor in a state of underpressure.

According to a preferred embodiment of the invention, the method comprises determining the switching points of time in a way that at the switching points of time, substantially no energy is stored in a compression or in a decompression of the liquid supplied to the pumping unit or in any elastic deformation of the liquid supply system's tubing or of any other system component, said elastic deformation being due to overpressure or to underpressure of the liquid.

According to a preferred embodiment of the invention, the method comprises determining the switching points of time in a way that an actual pressure of the liquid supplied to the pumping unit is substantially equal to a predefined regular pressure at said switching points.

According to a preferred embodiment of the invention, the method comprises determining the switching points of time in a way that the liquid supplied to the pumping unit is substantially at a predefined regular pressure at said switching points of time.

According to a preferred embodiment of the invention, the method comprises determining the switching points of time in a way that the liquid supplied to the pumping unit is substantially at a predefined regular pressure at said switching points of time, with the predefined regular pressure being the liquid's average pressure in the low-pressure region of the liquid supply system.

According to a preferred embodiment of the invention, the method comprises determining the switching points of time in a way that the liquid supplied to the pumping unit is substantially at a predefined regular pressure at said switching points of time, with the predefined regular pressure being the liquid's final static pressure in the low-pressure region of the liquid supply system.

According to a preferred embodiment of the invention, the liquid supply system further comprises a pressure sensor located downstream of the proportioning valve, the pressure sensor being configured for monitoring a pressure of the liquid supplied to the pumping unit; the method further comprising at least one of: selecting the switching points of time in accordance with the pressure determined by the pressure sensor; comparing the pressure determined by the pressure sensor with a predefined regular pressure, and determining the switching points in a way that the actual pressure is substantially equal to the predefined regular pressure at said switching points.

According to a preferred embodiment of the invention, the method comprises determining the switching points of time in advance for different solvents and flow rates according to a predetermined model of the liquids' behavior.

According to a preferred embodiment of the invention, when liquid is drawn in from selected ones of the solvent supply lines, the liquid performs oscillations between a first state characterized by minimum pressure and a second state characterized by maximum pressure.

According to a preferred embodiment of the invention, at the switching points of time, the liquid supplied to the pumping unit may still be in a state of oscillation, with the liquid oscillating between a first state characterized by minimum pressure and a second state characterized by maximum pressure.

According to a preferred embodiment of the invention, at the switching points of time when switching between different solvent supply lines is effected, dynamic disturbances of the liquid supplied to the pumping unit do not have to be settled yet.

According to a preferred embodiment of the invention, when liquid is drawn in from selected ones of the solvent supply lines, the liquid performs oscillations between a first state characterized by minimum pressure and a second state characterized by maximum pressure, with a time period of said oscillations depending on at least one of the hydraulic capacity of the liquid and the liquid supply system's tubing, the hydraulic restriction of the liquid supply system's tubing, and the mass inertia associated with the liquid in the tubing.

According to a preferred embodiment of the invention, the pumping unit comprises a piston pump with a piston reciprocating in a pump chamber, the method comprising at least one of: moving the piston in a non-uniform manner to reduce oscillating dynamics of the liquids that are drawn in, with the piston being slowed down before switching is effected, and with the piston being accelerated after switching has been effected; moving the piston in a non-uniform manner to vary intake speed during an intake stroke, with liquids being accelerated and decelerated smoothly during the intake stroke; operating the pumping unit to control the speed of the liquids that are taken in in a way that pressure extremes are avoided; operating the pumping unit to control the speed of the liquids that are taken in by optimizing the speed dynamics with a function that has a continuous change in speed, with steep speed changes being reduced or even avoided; operating the pumping unit to control the speed of the liquids that are taken in by optimizing the speed dynamics with a function that has a continuous change in acceleration or deceleration, with the result that steep speed changes being reduced or even avoided; operating the pumping unit to control the speed of the liquids that are taken in by optimizing the speed dynamics with a function that results in actively damping the intake pressure.

A liquid supply system according to embodiments of the present invention is configured for metering two or more liquids in controlled proportions and for supplying a resultant mixture. The liquid supply system comprises a plurality of solvent supply lines, each fluidically connected with a reservoir containing a liquid; a proportioning valve interposed between the solvent supply lines and an inlet of a pumping unit, the proportioning valve configured for modulating solvent composition by sequentially coupling selected ones of the solvent supply lines with the inlet of the pumping unit; the pumping unit being configured for taking in liquids from the selected solvent supply lines and for supplying a mixture of the liquids at its outlet; a control unit configured for controlling operation of the proportioning valve, wherein switching between different solvent supply lines is effected at one or more switching points of time that are chosen in a way that at said switching points of time, the liquid supplied to the pumping unit is in a predefined pressure range.

According to embodiments of the present invention, the liquid supply system further comprises at least one of: a pressure sensor located downstream of the proportioning valve, the pressure sensor being configured for monitoring a pressure of the liquid supplied to the pumping unit; a flow sensor located downstream of the proportioning valve, the flow sensor being configured for determining a flow of the liquid supplied to the pumping unit.

According to embodiments of the present invention, the pumping unit comprises a piston pump with a piston reciprocating in a pump chamber.

According to embodiments of the present invention, the liquid supply unit further comprises an auxiliary chamber fluidically coupled to the inlet of the pumping unit, the auxiliary chamber including a force loaded element or active element therein.

According to embodiments of the present invention, the auxiliary chamber is configured for receiving a mixture of liquids contained in the pumping unit, for mixing the liquids, and for resupplying the liquids to the pumping chamber.

According to embodiments of the present invention, the control unit is further configured for controlling the pumping unit's operation in a way that the sequential mixture of liquids contained in the pumping unit is transferred via the pumping unit's inlet to the auxiliary chamber and from the auxiliary chamber back to the pumping unit before the inlet valve is closed and the blended liquid is delivered at the pumping unit's outlet, thereby mixing the liquids to form a more homogeneous composition.

A liquid separation system according to embodiments of the present invention is configured for separating compounds of a sample liquid in a mobile phase. The liquid separation system comprises: a liquid supply system as described above, the liquid supply system being configured to drive the mobile phase through the liquid separation system; a separation unit, preferably a chromatographic column, configured for separating compounds of the sample liquid in the mobile phase.

According to embodiments of the present invention, the liquid separation system further comprises at least one of: a sample injector configured to introduce the sample liquid into the mobile phase; a detector configured to detect separated compounds of the sample liquid; a collection unit configured to collect separated compounds of the sample liquid; a data processing unit configured to process data received from the liquid separation system; a degassing apparatus for degassing the mobile phases.

Embodiments of the present invention might be embodied based on most conventionally available HPLC systems, such as the Agilent 1290 Series Infinity system, Agilent 1200 Series Rapid Resolution LC system, or the Agilent 1100 HPLC series (all provided by the applicant Agilent Technologies—see www.agilent.com—which shall be incorporated herein by reference).

One embodiment of an HPLC system comprises a pumping apparatus having a piston for reciprocation in a pump working chamber to compress liquid in the pump working chamber to a high pressure at which compressibility of the liquid becomes noticeable, and to deliver said liquid at high pressure.

One embodiment of an HPLC system comprises two pumping apparatuses coupled either in a serial or parallel manner. In the serial manner, as disclosed in EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially 180 degrees, with respect to a liquid outlet of the second pumping apparatus, so that only one pumping apparatus is supplying into the system while the other is intaking liquid (e.g. from the supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift.

The separating device preferably comprises a chromatographic column providing the stationary phase. The column might be a glass or steel tube (e.g. with a diameter from 10 μm to 5 mm and a length of 1 cm to 1 m) or a microliquidic column (as disclosed e.g. in EP 1577012 A1 or the Agilent 1200 Series HPLC-Chip/MS System provided by the applicant Agilent Technologies, see e.g. http://www.chem.agilent.com/Scripts/PDS.asp?|Page=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute separated, more or less one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a liquidized bed is used. Furthermore, there also exist monolithic columns for fast high performance liquid chromatography separations.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample liquid might comprise any type of process liquid, natural sample like juice, body liquids like plasma or it may be the result of a reaction like from a fermentation broth.

The liquid is preferably a liquid but may also be or comprise a gas and/or a supercritical liquid (as e.g. used in supercritical liquid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-120 MPa (500 to 1200 bar).

The HPLC system might further comprise a sampling unit for introducing the sample liquid into the mobile phase stream, a detector for detecting separated compounds of the sample liquid, a fractionating unit for outputting separated compounds of the sample liquid, or any combination thereof. Further details of HPLC system are disclosed with respect to the aforementioned Agilent HPLC series, provided by the applicant Agilent Technologies, under www.agilent.com which shall be in cooperated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s). The illustration in the drawing is schematically.

FIG. 1 shows part of a liquid separation system configured for supplying a flow of composite solvent;

FIG. 2 shows how different solvents are drawn in during an intake phase of the pumping unit;

FIG. 3 gives an overview of a liquid chromatography system;

FIG. 4 shows experimental results obtained for a composite solvent made of water and 1% to 10% acetone.

FIG. 5 illustrates the oscillatory behavior of the solvent in the tubing;

FIG. 6 shows pressure as a function of time;

FIG. 7 shows piston displacement as a function of time for three different piston movements;

FIG. 8 depicts the set-up of a liquid supply system comprising at least one pressure transducer; and

FIG. 9 shows a liquid supply system comprising an auxiliary chamber adapted for mixing the solvents that have been drawn in.

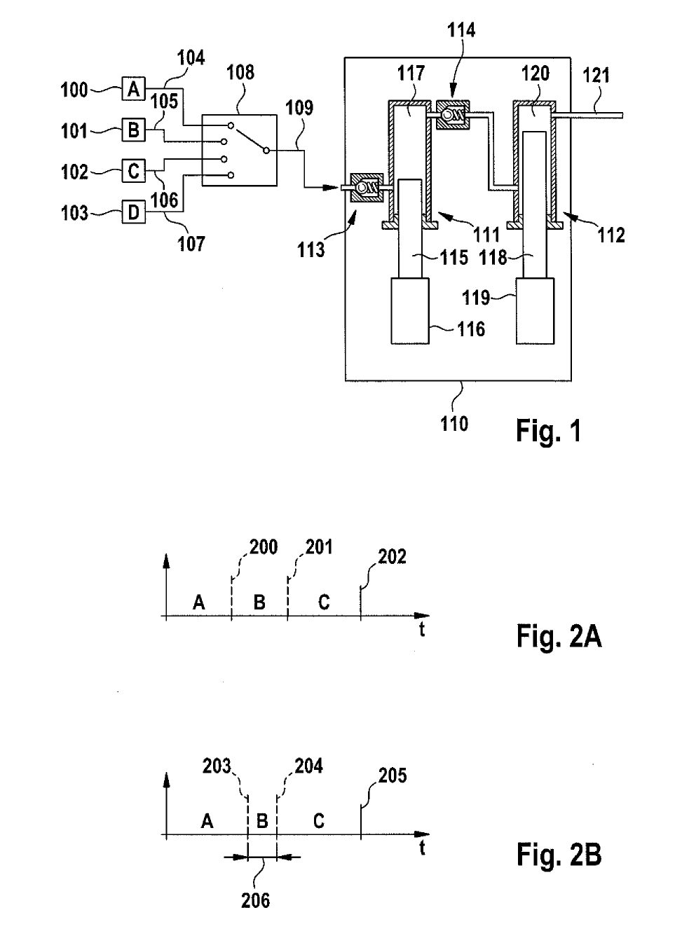

FIG. 1 shows a liquid supply system configured for metering liquids in controlled proportions and for supplying a resultant mixture. The liquid supply system comprises four reservoirs 100, 101, 102, 103, with each of the reservoirs containing a respective solvent, A, B, C, D. Each of the reservoirs 100 to 103 is fluidically connected via a respective liquid supply line 104, 105, 106, 107 with a proportioning valve 108. The proportioning valve 108 is configured to connect a selected one of the four liquid supply lines 104 to 107 with a supply line 109, and to switch between different liquid supply lines. The supply line 109 is connected with an inlet of a pumping unit 110. Hence, solvent metering is performed at the low-pressure side of the pumping unit 110.

In the example shown in FIG. 1, the pumping unit 110 comprises a first piston pump 111 fluidically connected in series with a second piston pump 112. The first piston pump 111 is equipped with an inlet valve 113 and with an outlet valve 114. A first piston 115 is driven by a first motor 116 and reciprocates within the first pump chamber 117. A second piston 118 is driven by a second motor 119 and reciprocates within a second pump chamber 120. Alternatively, both pistons can be operated by a common drive system, e.g. a differential drive.

During an intake phase of the first piston pump 111, the inlet valve 113 is open, the outlet valve 114 is shut, and the first piston 115 moves in the downward direction. Accordingly, solvent supplied via the supply line 109 is drawn into the first pump chamber 117. During the downward stroke of the first piston 115, the proportioning valve 108 may switch between different liquid supply lines and hence between different solvents. Thus, during the downward stroke of the first piston 115, different solvents may be drawn into the first pump chamber 117 one after the other. In an alternative construction, there may be individual inlet valves for each liquid supply line 104 to 107, which then are controlled like and instead of proportioning valve 108.

FIG. 2A shows an example of three different solvents A, B, C being drawn into the first pump chamber 117 during the first piston's downward stroke. Initially, the first liquid supply line 104 is connected to the pumping unit's inlet, and solvent A is drawn into the first pump chamber 117. After the first piston 115 has drawn in a certain amount of solvent A, the proportioning valve 108 switches from solvent A to solvent B at a point of time 200. Next, a certain amount of solvent B is drawn in via the second liquid supply line 105. At a point of time 201, the proportioning valve 108 switches from solvent B to solvent C. Then, a certain amount of solvent C is drawn into the first pump chamber 117. The point of time 202 indicates the end of the first piston's downward stroke. When the points of time 200, 201 are controlled in a coordinated manner, then at the end of the first piston's downward stroke, a defined solvent composition of solvents A, B, C is contained in the first pump chamber 117.

FIG. 2B shows another example where a large percentage of solvent A is mixed with a small percentage of solvent B. In this case, switching of the proportioning valve 108 is performed as follows: first, a certain amount of solvent A is drawn in. Then, at a point of time 203, the proportioning valve 108 switches from solvent A to solvent B, and a small amount of solvent B is drawn in. Then, at a point of time 204, the proportioning valve 108 switches back from solvent B to solvent A, and during the remaining part of the downward stroke, solvent A is drawn in. At the end of the first piston's downward stroke, at the point of time 205, the first pump chamber 117 contains a composite solvent comprising a large percentage of solvent A and a small percentage of solvent B.

During the downward stroke of the first piston 115, the second piston 118 performs an upward stroke and delivers a flow of fluid, and at the pumping unit's outlet 121, a flow of composite solvent at high pressure is provided.

After the respective amounts of different solvents have been drawn into the first pump chamber 117, the inlet valve 113 is shut, the first piston 115 starts moving in the upward direction and compresses the liquid contained in the first pump chamber 117 to system pressure. In an alternative construction, when the proportioning valve 108 is capable to withstand high pressure, an extra inlet valve 113 may be omitted. The outlet valve 114 opens, and during the following refill phase, the first piston 115 moves in the upward direction, the second piston 118 moves in the downward direction, and the composite solvent is transferred from the first pump chamber 117 to the second pump chamber 120. During the refill phase, the amount of composite solvent supplied by the first piston pump 111 usually exceeds the amount of composite solvent drawn in by the second piston pump 112, and hence, at the outlet 125, a continuous flow of composite solvent is maintained.

After a well-defined amount of composite solvent has been supplied from the first piston pump 111 to the second piston pump 112, the outlet valve 114 is shut, the second piston 118 moves in the upward direction, thus a continuous flow of composite solvent is maintained, while the first piston 115 starts moving in the downward direction, the inlet valve 113 is opened, and again different solvents are drawn into the first pump chamber 117.

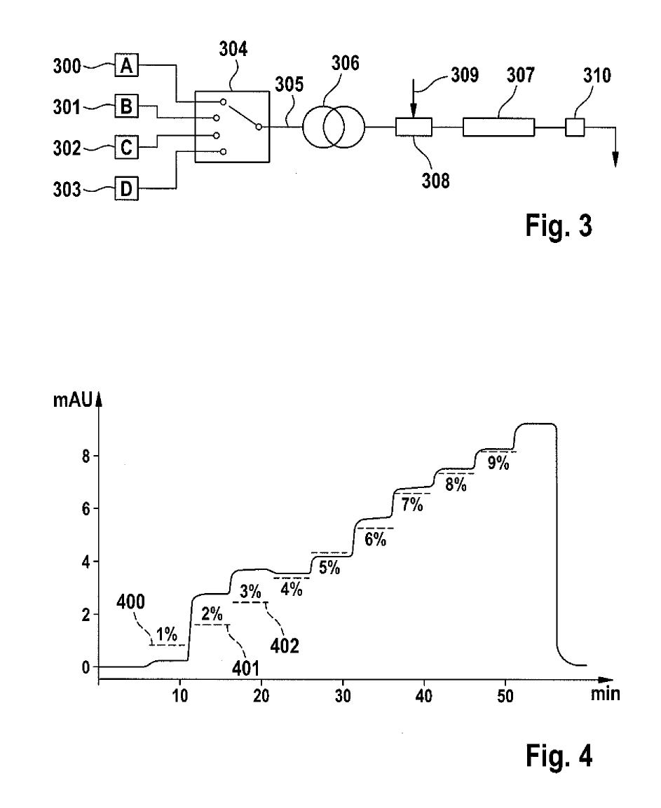

The liquid supply system shown in FIG. 1 may for example be used for supplying a flow of composite solvent to a separation device adapted for separating compounds of a sample liquid. FIG. 3 depicts the setup of a liquid separation system. The liquid separation system comprises four reservoirs 300 to 303 containing four different solvents A, B, C, D, which are fluidically coupled with a proportioning valve 304. The proportioning valve 304 is responsible for switching between different solvents and for providing the respective solvents to an inlet 305 at the low-pressure side of the pumping unit 306. Mixing of different solvents is effected at the low-pressure side of the pumping unit 306. The pumping unit 306 is configured to supply a flow of composite solvent to a separation device 307, which may for example be a chromatographic column. A sample injector 308 is located between the pumping unit 306 and the separation device 307. Via the sample injector 308, a sample liquid 309 may be introduced into the separation flow path. The flow of composite solvent supplied by the pumping unit 306 drives the sample's compounds through the separation device 307. During their passage through the separation device 307, the sample's compounds are separated. A detection unit 310 located downstream of the separation device 307 is configured to detect the various compounds of the sample as they appear at the outlet of the separation device 307.

The liquid supply system shown in FIG. 1 is well-suited for being used in a liquid separation system, for example in a liquid chromatography system. It is to be noted, however, that the liquid supply system shown in FIG. 1 may be used in other fields as well.

With regard to the liquid supply system shown in FIG. 1, it has been observed that compositional errors of the composite solvent provided at the outlet 121 are likely to occur when a large amount of a first solvent is mixed with a small amount of a second solvent. This corresponds to the situation depicted in FIG. 2B, where a large percentage of solvent A is mixed with a small percentage of solvent B, with solvent B being drawn in during the time interval 204.

To gain an improved understanding of these compositional errors, a mixture of water and a small amount of acetone has been studied, whereby the amount of acetone has been increased in steps from 0% to 10%. As shown in FIG. 4, the amount of acetone is increased from 0%, 1%, 2%, etc., up to 10% in steps of 1% as a function of time, whereby the respective amount of acetone is increased by correspondingly increasing the length of the time interval 206 in FIG. 2B. The respective concentration of the composite solvent obtained at the outlet 121 is measured by optical adsorbance and indicated in FIG. 4 in arbitrary units (mAU) as a solid line. In addition to the measured concentration, the desired concentration of 1%, 2%, etc. acetone is indicated as a dashed line. In case of 1% acetone, the measured value is considerably below the desired value 400 of 1% acetone. In case of 2% acetone, the measured value is considerably above the desired value 401 of 2% acetone, and also in case of 3% acetone, the measured value is above the desired value 402 of 3% acetone. In this example for composite solvents with more than 3% acetone, the deviation between the measured value and the desired value becomes less significant. It has to be noted that the deviation depends on a large set of parameters and conditions and may show different patterns for other conditions.

The reason for this behavior is related to the fluid dynamics and should be described here for the situation of solvent B. When the proportioning valve 108 switches from solvent A to solvent B, the volume of solvent B contained in liquid supply line 105 is fluidically connected, via the supply line 109, to the first pump chamber 117. The first piston 115 continues its downward movement, and due to the resulting underpressure in the first pump chamber 117, the volume of solvent B contained in the liquid supply line 105 is accelerated towards the first piston pump 111.

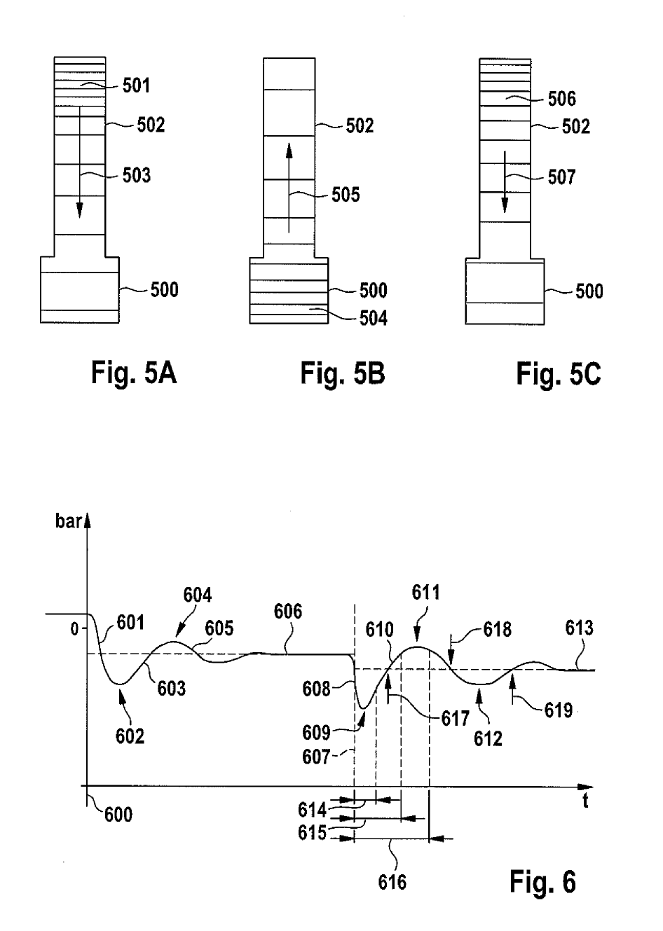

The resulting fluid dynamics are illustrated in FIGS. 5A to 5C. FIG. 5A shows the situation right after switching. Due to the underpressure in the pump chamber 500, the volume 501 of solvent B contained in the tubing 502 is accelerated towards the pump chamber 500, as indicated by arrow 503.

In order to level out the initial pressure difference in low damped systems, the speed of solvent B will raise above the intake speed of pump chamber 500. As shown in FIG. 5B, the accelerated mass of the volume of solvent B causes a compression 504 of the fluid contained in the pump chamber 500. The compression 504 is due to the inertia of the accelerated volume of solvent B. The compression 504 corresponds to a transient overpressure of the fluid contained in the pump chamber 500. Then, the compression 504 of the fluid in the pump chamber 500 gives rise to a relaxation and a resulting speed change, ultimately to a movement of the fluid in the opposite direction, as indicated by arrow 505.

FIG. 5C illustrates the next phase of movement. The fluid in the pump chamber 500 is decompressed, and accordingly, an underpressure of the fluid in the pump chamber 500 may be detected. The fluid in the tubing 502 then is compressed, and this compression 506 may cause a dilation of the tubing. Furthermore, the compression 506 may cause an acceleration 507 of the fluid. Hence, an oscillatory behavior of the fluid is observed; the fluid swashes back and forth between the tubing 501 and the pump chamber 500. Accordingly, the pressure in the pump chamber 500 oscillates between a state of overpressure and a state of underpressure. But even if the actual magnitude of this oscillatory movement is not high enough to really reverse the flow, just the fact that under certain pressure conditions at specific points in time the liquid and all elastic components between the proportioning valve 108 and the pump chamber allow more or less solvent being present, already disturbs the intake of a defined mixture of solvent.

FIG. 6 shows the pressure at the inlet of the pumping unit 110 as a function of time. At a point of time 600, the proportioning valve 108 is switched, and the liquid supply line 104 containing solvent A is fluidically connected with the pumping unit 110. Right after switching, a pressure drop 601 is observed, and then, the pressure reaches a minimum 602. As a result, the volume of solvent A contained in the liquid supply line 104 is accelerated towards the first pump chamber 117, and due to the inertia of the accelerated volume of solvent A, the fluid in the pump chamber is compressed, and an increase 603 of the pressure in the pump chamber is observed. This leads to an overpressure 604, which causes a net movement of the fluid in the opposite direction, and therefore, a decrease 605 of the pressure is observed. The oscillatory movement of the fluid causes corresponding oscillations of the pressure detected at the pumping unit's inlet, whereby the amplitude of said oscillations declines as a function of time, like is well known by theory of damped oscillations. Thus, a stable level 606 of the pressure is reached. Then, at a point of time 607, the proportioning valve 108 switches from solvent A to solvent B, and accordingly, the volume of solvent B contained in the liquid supply line 105 is fluidically coupled with the pumping unit. Right after switching, there is a pressure drop 608. The resulting underpressure 609 in the first pump chamber 117 causes an acceleration of the volume of solvent B contained in the liquid supply line 105 in the direction of the pumping unit 110. As a consequence, a rise 610 of pressure is detected, and the pressure in the first pump chamber 117 reaches a maximum 611. Now, the fluid in the first pump chamber 117 is compressed, which gives rise to a movement in the opposite direction. As a consequence, the pressure decreases to a minimum 612. Hence, the pressure in the first pump chamber 117 oscillates, whereby the amplitude of the oscillation decreases as a function of time until a stable level 613 is reached.

The oscillations shown in FIG. 6 are the reason for the compositional errors shown in FIG. 4. These compositional errors are particularly significant when small amounts of solvent B are drawn in, which means that the time interval 204 shown in FIG. 2B is such short that the oscillations have not settled yet when the proportioning valve switches from solvent B to solvent A.

In FIG. 6, three different time intervals 614, 615, 616 are indicated, with solvent B being drawn in during said time intervals. For example, in case solvent B is only drawn in during the time interval 614, the solvent B is in an expanded state when switching occurs, and therefore, the amount of solvent B that is drawn in is smaller than it should be. This corresponds to the case of 1% acetone tracer in FIG. 4, where the amount of solvent B that is actually drawn in is smaller than the desired value 400 of 1% acetone. Hence, the amount of solvent that is drawn in during the time interval 614 is not sufficient.

In contrast, in case solvent B is drawn in during a somewhat longer time interval 615, the volume of solvent B that is drawn in is in a compressed state when the proportioning valve switches back from solvent B to solvent A. Therefore, the amount of solvent B that is drawn in is actually too large. This corresponds to the case of 2% acetone tracer in FIG. 4. There, the amount of acetone that is actually measured is significantly above the correct value 401 of 2% acetone tracer. At the moment of switching, the solvent is in a compressed state, and therefore, too much acetone containing liquid is drawn in.

The same holds true for the somewhat longer time interval 616, which may for example correspond to the case of 3% acetone containing liquid in FIG. 4. Also in this case, the pressure of the fluid in the pump chamber is above the nominal regular pressure, and therefore, the amount of solvent B that has actually passed the proportioning valve is larger than it should be and exceeds the regular value 402. Hence, the oscillatory behavior of the volume of solvent in the inlet line that is actually drawn in at the point of time when the proportioning valve closes is directly related to the resulting compositional errors of the composite solvent, which are particularly significant for relatively short valve-ON times, say small amounts of solvent B as presented in this example.

According to embodiments of the present invention, it is attempted to reduce or even eliminate these compositional errors of the composite solvent by carefully choosing the switching point when the proportioning valve is switched back from solvent B to solvent A. Instead of just considering a linear relation of valve duty cycle, the control will also consider actual pressure conditions. In case the solvent in the pump chamber is in a state of overpressure at the switching point of time, the amount of solvent B that is drawn in is too large. In contrast, in case the solvent in the pump chamber is in a state of underpressure at the switching point of time, the amount of solvent B that is drawn in is too small. Therefore, at the switching point of time, the solvent in the pump chamber should be at regular pressure, or at least close to regular pressure. According to embodiments of the present invention, it is avoided that switching from solvent B to solvent A occurs at a point of time when the solvent contained in the pump chamber is either in a state of underpressure or in a state of overpressure, because both the state of underpressure and the state of overpressure lead to compositional errors of the composite solvent.

In the example of FIG. 6, switching from solvent B to solvent A may for example occur at the point of time 617, because at the point of time 617, the solvent contained in the pump chamber is at regular pressure. At the point of time 617, the solvent contained in the pump chamber is neither in a state of underpressure nor in a state of overpressure. The point of time 618 is also a suitable point of time for switching back from solvent B to solvent A, because at the point of time 618, the solvent in the pump chamber is at regular pressure. A further possibility is to choose the point of time 619 as a switching point for switching back from solvent B to solvent A, because at the point of time 619, the solvent in the pump chamber is at regular pressure as well. Hence, by choosing one of the points of time 617, 618, 619 (or any other point where the solvent in the pump chamber is at regular pressure) as a switching point for switching back from solvent B to solvent A, compositional errors of the composite solvent are reduced or even eliminated. Thus, even for small amounts of solvent B (for example below 5% of solvent B), it is possible to supply a composite solvent with a correct mixing ratio of solvent A and solvent B. As a consequence, for any measurement that depends on a correct mixing ratio of a composite solvent supplied by a liquid supply unit, like for example liquid chromatography, a significant increase of measurement accuracy is accomplished. Even for small amounts of solvent B, accurate measurement results are obtained.

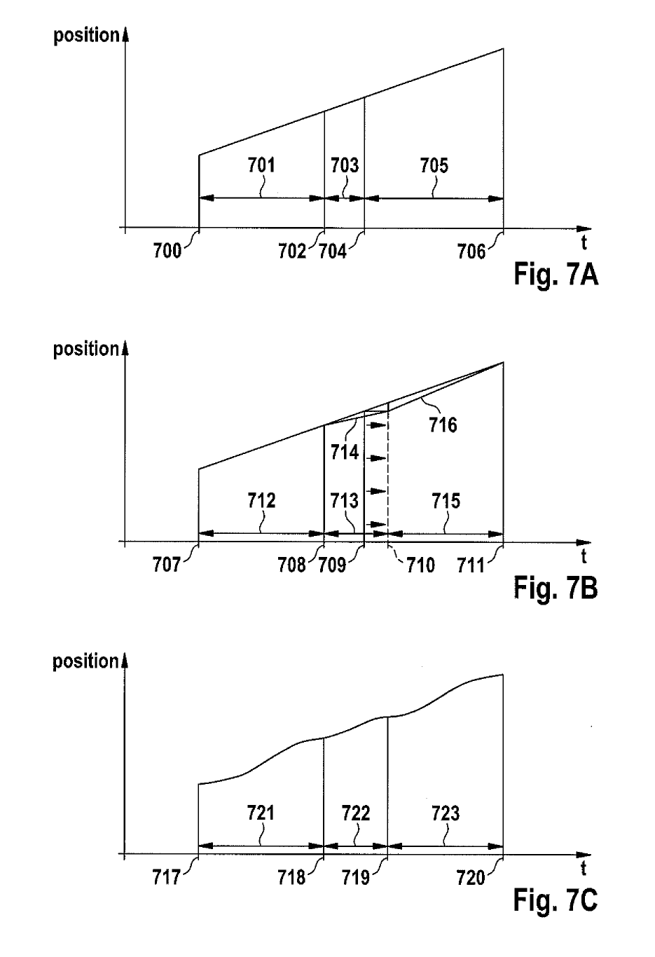

In prior art solutions, the first piston of the first piston pump has performed a linear movement during the intake phase. This is illustrated in FIG. 7A, which depicts piston position as a function of time. At a point of time 700, the first piston starts moving in the downward direction. During the time interval 701, solvent A is drawn in at a constant rate. At a point of time 702, the proportioning valve switches from solvent A to solvent B. During the subsequent time interval 703, the first piston continues moving at constant velocity, and solvent B is drawn in. At the point of time 704, switching from solvent B back to solvent A is performed, and during the time interval 705, solvent A is drawn in at a constant rate. At the point of time 706, the first piston has reached its final position. Due to the constant velocity of the first piston during the intake phase, there is a linear relationship between the amounts of solvent A and solvent B which are drawn in and the respective lengths of the time intervals 701, 703, 705.

According to embodiments of the present invention, the switching point for switching from solvent B to solvent A is chosen such that any oscillatory movements of the solvent in the first pump chamber do not disturb solvent composition. In particular, the switching point for switching from solvent B to solvent A is chosen such that the solvent in the first piston pump is neither in a compressed state nor in an expanded state at the point of switching.

FIG. 7B shows the piston movement according to an embodiment of the present invention. Compared to the prior art solution, the starting point 707 and the first switching point 708 remain unchanged, but the second switching point is shifted from a former switching point 709 to a new switching point 710, with the new switching point 710 being chosen under consideration of the oscillatory behavior of the solvent. At the new switching point 710, the solvent in the first piston pump is neither in a state of overpressure nor in a state of underpressure. At the point of time 711, the intake phase is finished. In order to draw in the right amounts of solvent A and solvent B, the piston movement has to be adapted to the modified timing. In time interval 712, the slope of the piston movement remains unchanged. However, as the second switching point has been shifted to the right, the new time interval 713 is larger than the former time interval 703. Therefore, in new time interval 713, the slope 714 is decreased. The new time interval 715 is smaller than the former time interval 705. Accordingly, in time interval 715, the slope 716 of the piston movement is increased. Hence, it is possible to adapt the piston movement in a way that the correct amounts of solvent A and solvent B are drawn in during the intake phase.

It should be noted that during the intake phase, the outlet valve 114 of the first piston pump 111 shown in FIG. 1 is shut, and therefore, during the intake phase, the first piston 115 may perform any arbitrary movement as long as the right amounts of solvent A and solvent B are drawn in. FIG. 7C shows a piston movement according to another embodiment of the invention. In FIG. 7C, the starting point 717, the first switching point 718, the second switching point 719 and the end point 720 correspond to the respective points of time 706, 707, 709, 710 in FIG. 7B. Like in FIG. 7B, the second switching point 719 is chosen in a way that at the second switching point 719, the solvent in the first piston pump is neither in a state of overpressure nor in a state of underpressure. Nevertheless, compared to FIG. 7B, the piston movement is different. During the time interval 721, the first piston is slowly accelerated, then solvent A is drawn in, and then the first piston is decelerated. At the first switching point of time 718, the piston velocity is rather low or even zero. Then, during the subsequent time interval 722, the first piston is smoothly accelerated, solvent B is drawn in, and the first piston is slowly decelerated. At the second switching point 719, the piston velocity is rather low or even zero. Then, during the time interval 723, the first piston is accelerated, draws in solvent A, and is decelerated. The piston movement depicted in FIG. 7C allows for a smooth intake of the various solvents.

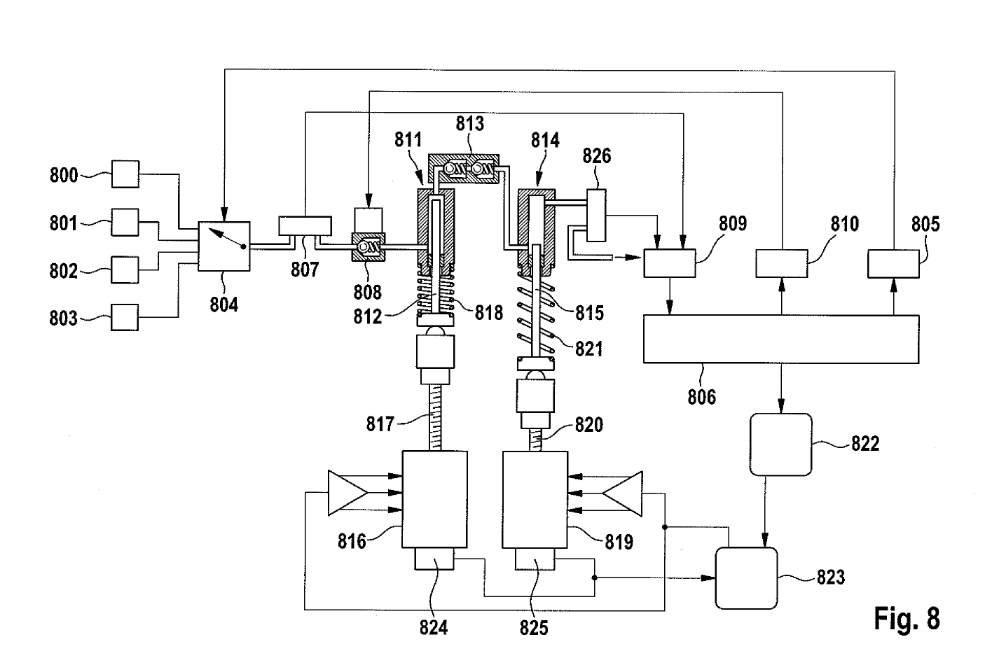

For selecting a suitable switching point for switching from solvent B back to solvent A, it is useful to track pressure variations at the inlet of the pumping unit. For this purpose, a pressure transducer may be included in the flow path between the proportioning valve and the inlet valve of a pumping unit. FIG. 8 shows a liquid supply system comprising at least one pressure transducer. The liquid supply system of FIG. 8 comprises four reservoirs 800 to 803 containing four different solvents A, B, C, and D. The four reservoirs 800 to 803 are fluidically connected, via respective liquid supply lines, with a proportioning valve 804. The proportioning valve 804 is adapted for selectively coupling one of the four reservoirs 800 to 803 with an inlet of a pumping unit. The proportioning valve 804 is controlled by a gradient control 805, which is controlled by a system controller 806. To monitor any oscillatory behavior of solvent pressure, a pressure transducer 807 is included in the flow path between the proportioning valve 804 and the inlet valve 808 of the pumping unit. The pressure transducer 807 is connected to an analog-/digital converter 809, which is adapted for converting analog measurement values into corresponding digital measurement values. The digital measurement values are supplied to the system controller 806. The system controller 806 is adapted for analyzing oscillations of the pressure measured by the pressure transducer 807 and for determining suitable switching points for the proportioning valve 804. The switching points determined by the system controller 806 are forwarded to the gradient control 805, and the gradient control 805 performs switching of the proportioning valve 804 in accordance with the determined switching points.

The inlet valve 808 of the pumping unit may be controlled by an inlet control 810, which is coupled with the system controller 806. The inlet control 810 is configured to open and shut the inlet valve 808 during the intake phase.

The pumping unit comprises a first piston pump 811 with a first piston 812, which is fluidically coupled, via an outlet valve 813, with a second piston pump 814, which comprises a second piston 815. The first piston 812 is driven by a first motor 816 with a first threaded bold 817, with a first spring 818 pressing the first piston 812 against the first threaded bolt 817. Similarly, the second piston 815 is driven by a second motor 819 and a second threaded bold 820, with a second spring 821 pressing the second piston 815 against the second threaded bolt 820. Both the first motor 816 and the second motor 819 are controlled by a pump drive control 822 and a position servo 823. The position servo 823 receives the actual position of the first motor 816 from the first encoder 824 and receives the actual position of the second motor 819 from the second encoder 825. The position servo 823 controls the operation of the first motor 816 and the second motor 819 in accordance with these feedback signals.

Optionally, the liquid supply system shown in FIG. 8 may further comprise a second pressure transducer 826 located at the outlet of the second piston pump 814. The pressure transducer 826 may be adapted for monitoring the pressure of the flow of fluid supplied by the liquid supply system. The analog-/digital-converter 809 converts the analog values provided by the second pressure transducer 826 into corresponding digital values, and said digital values may be analyzed and evaluated by the system controller 806.

In the embodiment shown in FIG. 8, the optimum point of time for switching between a first solvent and a second solvent is determined by monitoring and evaluating any oscillations of solvent pressure. However, there exist other possibilities for tracking and evaluating oscillations of solvents in the liquid supply line. For example, a flow sensor may be included in the liquid supply line connecting the proportioning valve 804 and the inlet of the pumping unit. By monitoring the flow of solvent, any oscillatory behavior of the solvent may be detected.

A third possibility is to determine optimum switching times for the proportioning valve 804 in advance for different solvents, different flow rates and different gradients, and to store the obtained optimum switching times in a table that is accessible to the system controller 806. For each situation, the system controller 806 may read an optimum switching point from the table and control the liquid supply system accordingly.

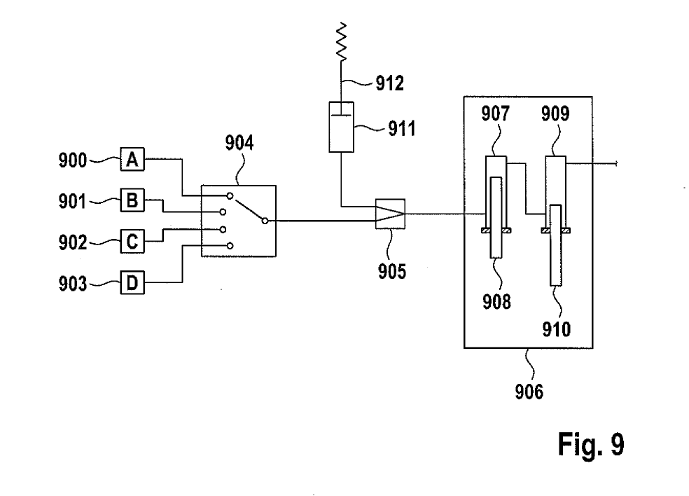

When two or more different liquids are consecutively drawn into the first piston pump, it may be desirable to further mix the different solvents, in order to obtain a homogenous composite solvent. FIG. 9 shows a setup configured for mixing various different components of a composite solvent. In FIG. 9, four different reservoirs 900 to 903 containing different solvents are fluidically coupled with a proportioning valve 904. The outlet of the proportioning valve 904 is fluidically connected, via the switch 905, with an inlet of a pumping unit 906 comprising a first piston pump 907 with a first piston 908 and a second piston pump 909 with a second piston 910. During an intake phase, various different solvents are drawn into the pump chamber of the first piston pump 907. Then, to mix the various different solvents, the first piston 908 starts moving in the upward direction while the second piston pump still supplies flow to the system. It pushes the composite solvent out of the pump chamber of the first piston pump 907. Thus, a flow of composite solvent is provided at the inlet of the pumping unit 906, said flow being directed, via the switch 905, to an auxiliary chamber 911. The auxiliary chamber 911 comprises an active member 912, which may e.g. be a spring-loaded active member, or which may e.g. be driven by a dedicated actuation mechanism. The composite solvent is transferred from the pump chamber of the first piston pump 907 to the auxiliary chamber 911. Then, the first piston 908 starts moving in the downward direction and draws in the solvent contained in the auxiliary chamber 911, while the active member 912 moves downward. Thus, the composite solvent is supplied from the auxiliary chamber 911 via the switch 905 to the pump chamber of the first piston pump 907 again. By moving the volume of composite solvent contained in the pump chamber of the first piston pump 907 back and forth between the pump chamber and the auxiliary chamber 911, the various components of the composite solvent mix, and a homogenous composite solvent is obtained. After mixing, the volume of composite solvent is transferred from the first piston pump 907 to the second piston pump 909 and supplied at the outlet of the pumping unit 906.

1. A method for metering two or more liquids in controlled proportions in a liquid supply system and for supplying a resultant mixture, the liquid supply system comprising a plurality of solvent supply lines, each fluidically connected with a reservoir containing a liquid, a proportioning valve interposed between the solvent supply lines and an inlet of a pumping unit, the proportioning valve configured for modulating solvent composition by sequentially coupling selected ones of the solvent supply lines with the inlet of the pumping unit, with the pumping unit being configured for taking in liquids from the selected solvent supply lines and for supplying a mixture of the liquids at its outlet; the method comprising:
drawing in a first liquid into the pumping unit via a first solvent supply line;
determining one or more switching points of time for switching between different solvent supply lines, the switching points of time being determined in a way that at said switching points of time, the liquid supplied to the pumping unit is in a predefined pressure range;
switching from the first solvent supply line to a second solvent supply line at one of said switching points of time;
drawing in a second liquid into the pumping unit via the second solvent supply line.

2. The method of claim 1, further comprising at least one of:
monitoring pressure at the inlet of the pumping unit to determine the switching points of time for switching between different solvent supply lines;
determining the switching points of time in a way that at said switching points of time, the liquid supplied to the pumping unit essentially is neither in a state of overpressure nor in a state of underpressure;
determining the switching points of time in a way that at the switching points of time, substantially no energy is stored in a compression or in a decompression of the liquid supplied to the pumping unit or in any elastic deformation of the liquid supply system's tubing or of any other system component, said elastic deformation being due to overpressure or to underpressure of the liquid;
determining the switching points of time in a way that an actual pressure of the liquid supplied to the pumping unit is substantially equal to a predefined regular pressure at said switching points;
determining the switching points of time in a way that the liquid supplied to the pumping unit is substantially at a predefined regular pressure at said switching points of time;
determining the switching points of time in a way that the liquid supplied to the pumping unit is substantially at a predefined regular pressure at said switching points of time, with the predefined regular pressure being the liquid's average pressure in the low-pressure region of the liquid supply system;
determining the switching points of time in a way that the liquid supplied to the pumping unit is substantially at a predefined regular pressure at said switching points of time, with the predefined regular pressure being the liquid's final static pressure in the low-pressure region of the liquid supply system.

3. The method of claim 1, wherein the liquid supply system further comprises a pressure sensor located downstream of the proportioning valve, the pressure sensor being configured for monitoring a pressure of the liquid supplied to the pumping unit; the method further comprising at least one of:
selecting the switching points of time in accordance with the pressure determined by the pressure sensor;
comparing the pressure determined by the pressure sensor with a predefined regular pressure, and
determining the switching points in a way that the actual pressure is substantially equal to the predefined regular pressure at said switching points.

4. The method of claim 1, further comprising:
determining the switching points of time in advance for different solvents and flow rates according to a predetermined model of the liquids' behavior.

5. The method of claim 1, comprising at least one of:
when liquid is drawn in from selected ones of the solvent supply lines, the liquid performs oscillations between a first state characterized by minimum pressure and a second state characterized by maximum pressure;
at the switching points of time, the liquid supplied to the pumping unit may still be in a state of oscillation, with the liquid oscillating between a first state characterized by minimum pressure and a second state characterized by maximum pressure;
at the switching points of time when switching between different solvent supply lines is effected, dynamic disturbances of the liquid supplied to the pumping unit do not have to be settled yet;
when liquid is drawn in from selected ones of the solvent supply lines, the liquid performs oscillations between a first state characterized by minimum pressure and a second state characterized by maximum pressure, with a time period of said oscillations depending on at least one of the hydraulic capacity of the liquid and the liquid supply system's tubing, the hydraulic restriction of the liquid supply system's tubing, and the mass inertia associated with the liquid in the tubing.

6. The method of claim 1, wherein the pumping unit comprises a piston pump with a piston reciprocating in a pump chamber, the method comprising at least one of:
moving the piston in a non-uniform manner to reduce oscillating dynamics of the liquids that are drawn in, with the piston being slowed down before switching is effected, and with the piston being accelerated after switching has been effected;
moving the piston in a non-uniform manner to vary intake speed during an intake stroke, with liquids being accelerated and decelerated smoothly during the intake stroke;
operating the pumping unit to control the speed of the liquids that are taken in in a way that pressure extremes are avoided;
operating the pumping unit to control the speed of the liquids that are taken in by optimizing the speed dynamics with a function that has a continuous change in speed, with steep speed changes being reduced or even avoided;
operating the pumping unit to control the speed of the liquids that are taken in by optimizing the speed dynamics with a function that has a continuous change in acceleration or deceleration, with the result that steep speed changes being reduced or even avoided;
operating the pumping unit to control the speed of the liquids that are taken in by optimizing the speed dynamics with a function that results in actively damping the intake pressure.

7. A software program or product, preferably stored on a data carrier, for controlling or executing the method of claim 1, when run on a data processing system.

8. A liquid supply system configured for metering two or more liquids in controlled proportions and for supplying a resultant mixture, the liquid supply system comprising
a plurality of solvent supply lines, each fluidically connected with a reservoir containing a liquid;
a proportioning valve interposed between the solvent supply lines and an inlet of a pumping unit, the proportioning valve configured for modulating solvent composition by sequentially coupling selected ones of the solvent supply lines with the inlet of the pumping unit;
the pumping unit being configured for taking in liquids from the selected solvent supply lines and for supplying a mixture of the liquids at its outlet;
a control unit configured for controlling operation of the proportioning valve, wherein switching between different solvent supply lines is effected at one or more switching points of time that are chosen in a way that at said switching points of time, the liquid supplied to the pumping unit is in a predefined pressure range.

9. The liquid supply system of claim 8, further comprising at least one of:
a pressure sensor located downstream of the proportioning valve, the pressure sensor being configured for monitoring a pressure of the liquid supplied to the pumping unit;
a flow sensor located downstream of the proportioning valve, the flow sensor being configured for determining a flow of the liquid supplied to the pumping unit;
the pumping unit comprises a piston pump with a piston reciprocating in a pump chamber;
during an intake stroke of the piston movement, when liquid is drawn in via the inlet of the pumping unit, the proportioning valve performs switching between different solvent supply lines;
the proportioning valve has a plurality of switching valves, with the switching valves being sequentially actuated during an intake stroke of the pumping unit;
predefined portions of an intake stroke of the piston are assigned to different solvents that are drawn in into the pumping unit, wherein proportioning is done by volumetric packets instead of time slices.

10. The liquid supply system of claim 8, further comprising an auxiliary chamber fluidically coupled to the inlet of the pumping unit, the auxiliary chamber including a force loaded element or active element therein.

11. The liquid supply system of the preceding claim 10, comprising at least one of:
the auxiliary chamber is configured for receiving a mixture of liquids contained in the pumping unit, for mixing the liquids, and for resupplying the liquids to the pumping chamber;
the control unit is further configured for controlling the pumping unit's operation in a way that the sequential mixture of liquids contained in the pumping unit is transferred via the pumping unit's inlet to the auxiliary chamber and from the auxiliary chamber back to the pumping unit before the inlet valve is closed and the blended liquid is delivered at the pumping unit's outlet.

12. A liquid separation system for separating compounds of a sample liquid in a mobile phase, the liquid separation system comprising:
a liquid supply system according to claim 8, the liquid supply system being configured to drive the mobile phase through the liquid separation system;
a separation unit, preferably a chromatographic column, configured for separating compounds of the sample liquid in the mobile phase.

13. The liquid separation system of claim 12, further comprising at least one of:
a sample injector configured to introduce the sample liquid into the mobile phase;
a detector configured to detect separated compounds of the sample liquid;
a collection unit configured to collect separated compounds of the sample liquid;
a data processing unit configured to process data received from the liquid separation system;
a degassing apparatus for degassing the mobile phase.

14. A method for metering two or more liquids in controlled proportions in a liquid supply system and for supplying a resultant mixture, the liquid supply system comprising a plurality of solvent supply lines, each fluidically connected with a reservoir containing a liquid, a proportioning valve interposed between the solvent supply lines and an inlet of a pumping unit, the proportioning valve configured for modulating solvent composition by sequentially coupling selected ones of the solvent supply lines with the inlet of the pumping unit, with the pumping unit being configured for taking in liquids from the selected solvent supply lines and for supplying a mixture of the liquids at its outlet, and further comprising an auxiliary chamber fluidically coupled to the inlet of the pumping unit, the auxiliary chamber including a force loaded element or active element therein; the method comprising:
drawing in a first liquid into the pumping unit via a first solvent supply line;
switching from the first solvent supply line to a second solvent supply line;
drawing in a second liquid into the pumping unit via the second solvent supply line;
transferring a mixture of liquids contained in the pumping unit via the pumping unit's inlet to the auxiliary chamber fluidically coupled to said inlet, and from the auxiliary chamber back to the pumping unit before the blended liquid is delivered at the pumping unit's outlet.

15. (canceled)

16. The method of claim 2, wherein the liquid supply system further comprises a pressure sensor located downstream of the proportioning valve, the pressure sensor being configured for monitoring a pressure of the liquid supplied to the pumping unit; the method further comprising at least one of:
selecting the switching points of time in accordance with the pressure determined by the pressure sensor;
comparing the pressure determined by the pressure sensor with a predefined regular pressure, and
determining the switching points in a way that the actual pressure is substantially equal to the predefined regular pressure at said switching points.

17. The method of claim 2, further comprising:
determining the switching points of time in advance for different solvents and flow rates according to a predetermined model of the liquids' behavior.

18. The method of claim 2, comprising at least one of:
when liquid is drawn in from selected ones of the solvent supply lines, the liquid performs oscillations between a first state characterized by minimum pressure and a second state characterized by maximum pressure;
at the switching points of time, the liquid supplied to the pumping unit may still be in a state of oscillation, with the liquid oscillating between a first state characterized by minimum pressure and a second state characterized by maximum pressure;
at the switching points of time when switching between different solvent supply lines is effected, dynamic disturbances of the liquid supplied to the pumping unit do not have to be settled yet;
when liquid is drawn in from selected ones of the solvent supply lines, the liquid performs oscillations between a first state characterized by minimum pressure and a second state characterized by maximum pressure, with a time period of said oscillations depending on at least one of the hydraulic capacity of the liquid and the liquid supply system's tubing, the hydraulic restriction of the liquid supply system's tubing, and the mass inertia associated with the liquid in the tubing.

19. The method of claim 2, wherein the pumping unit comprises a piston pump with a piston reciprocating in a pump chamber, the method comprising at least one of:
moving the piston in a non-uniform manner to reduce oscillating dynamics of the liquids that are drawn in, with the piston being slowed down before switching is effected, and with the piston being accelerated after switching has been effected;
moving the piston in a non-uniform manner to vary intake speed during an intake stroke, with liquids being accelerated and decelerated smoothly during the intake stroke;
operating the pumping unit to control the speed of the liquids that are taken in in a way that pressure extremes are avoided;
operating the pumping unit to control the speed of the liquids that are taken in by optimizing the speed dynamics with a function that has a continuous change in speed, with steep speed changes being reduced or even avoided;
operating the pumping unit to control the speed of the liquids that are taken in by optimizing the speed dynamics with a function that has a continuous change in acceleration or deceleration, with the result that steep speed changes being reduced or even avoided;
operating the pumping unit to control the speed of the liquids that are taken in by optimizing the speed dynamics with a function that results in actively damping the intake pressure.

20. A software program or product, preferably stored on a data carrier, for controlling or executing the method of claim 2, when run on a data processing system.

21. The liquid supply system of claim 9, further comprising an auxiliary chamber fluidically coupled to the inlet of the pumping unit, the auxiliary chamber including a force loaded element or active element therein.
